(19) United States
(12) Patent Application Publication
(10) Pub. No.: US 2019/0318386 A1
(43) Pub. Date: Oct. 17, 2019

(54) INFORMATION PROCESSING METHOD, PROGRAM, INFORMATION PROCESSING SYSTEM, AND INFORMATION PROCESSING APPARATUS

(71) Applicant: NEC CORPORATION, Tokyo (JP)

(72) Inventor: Tsugunori TAKATA, Tokyo (JP)

(73) Assignee: NEC CORPORATION, Tokyo (JP)

(21) Appl. No.: 16/338,278

(22) PCT Filed: Mar. 18, 2017
(86) PCT No.: PCT/JP2017/018680

§ 371 Date: Mar. 29, 2019

(30) Foreign Application Priority Data
Sep. 30, 2016 (JP) 2016-194099

(51) Int. Cl. G06Q 30/02; G06Q 30/06

(52) U.S. Cl. CPC G06Q 30/0261; G06Q 30/0639; G06Q 30/0255; G06Q 30/0259

(57) ABSTRACT

In a case where a store within a predetermined distance from a portable terminal of a user has a product associated with the user in stock, an information processing apparatus (2000) outputs information related to the store and the product to the portable terminal of the user. A determination unit (2020) determines the store having the product associated with the user in stock. A judging unit (2040) judges whether or not a distance between the portable terminal of the user and the store is less than or equal to the predetermined distance. An output control unit (2060) outputs the information related to the store and the product to the portable terminal of the user in a case where it is judged that the distance between the portable terminal of the user and the store is less than or equal to the predetermined distance.

### TECHNICAL FIELD

The present invention relates to an information processing method, a program, an information processing system, and an information processing apparatus.

### BACKGROUND ART

A system that performs various types of notification for a user has been developed. For example, Patent Document 1 discloses a product purchase reminder system. In this system, a portable terminal of the user acquires an image (partial image) of a product posted in an electronic flyer and transmits the image to a reminding server. The reminding server that acquires the partial image acquires positional information related to a store of an advertiser in the electronic flyer and generates reminder information that includes the partial image and the positional information related to the store. In a case where the portable terminal (user) approaches the store, the reminding server transmits a reminding notification instruction to the portable terminal using the generated reminder information and positional information related to the portable terminal.

### RELATED DOCUMENT

### Patent Document

[Patent Document 1] Japanese Patent Application Publication No. 2015-194820

### SUMMARY OF THE INVENTION

### Technical Problem

In the system of Patent Document 1, reminding notification is made for the store of the advertiser in the electronic flyer displayed on the portable terminal. Thus, in a case where the store of the advertiser in the electronic flyer does not have the product in stock, reminding notification is not made to the user even in a case where another store has the product desired by the user in stock. In addition, since the reminding information is based on the post in the electronic flyer, there is a possibility of a situation in which the product posted in the electronic flyer is sold out even in a case where the user stops by the store in accordance with the reminding notification.

The present invention is conceived in view of the above problem. An object of the present invention is to provide a technology for increasing opportunities for a user to purchase a product.

### Solution to Problem

A first information processing method of the present invention is executed by a computer. The information processing method includes (1) a determination step of determining a store having a target product associated with a first user in stock, (2) a judging step of judging whether or not a distance between a portable terminal of the first user and the determined store is less than or equal to a predetermined distance, and (3) an output control step of outputting information related to the determined store and the target product to the portable terminal of the first user in a case where it is judged that the distance between the portable terminal of the first user and the determined store is less than or equal to the predetermined distance.

A second information processing method of the present invention is executed by a computer.

The information processing method includes (1) a determination step of determining a store within a predetermined distance from a portable terminal of a first user, (2) a judging step of judging whether or not a target product that is associated with the first user is included in products in stock in the determined store, and (3) an output control step of outputting information related to the determined store and the target product to the portable terminal of the first user in a case where it is judged that the target product is included in the products in stock in the determined store.

A third information processing method of the present invention is executed by a computer.

The information processing method includes an output control step of outputting information related to a second product different from a first product to a user who purchased the first product.

The information related to the second product includes information determining a counter of the second product.

The first product and the second product are sold at different counters in the same store.

A first program of the present invention causes a computer to execute (1) a judging process of acquiring determination information determining a store having a target product associated with a first user in stock, and judging whether or not a distance between a portable terminal of the first user and the determined store is less than or equal to a predetermined distance, and (2) an output control process of outputting information related to the determined store and the target product to the portable terminal of the first user in a case where it is judged that the distance between the portable terminal of the first user and the determined store is less than or equal to the predetermined distance.

A second program of the present invention causes a computer to execute (1) a determination process of determining a store within a predetermined distance from a portable terminal of a first user, (2) a judging process of judging whether or not a target product that is associated with the first user is included in products in stock in the determined store, and (3) an output control process of outputting information related to the determined store and the target product to the portable terminal of the first user in a case where it is judged that the target product is included in the products in stock in the determined store.

An information processing system of the present invention includes a server apparatus and a portable terminal.

The server apparatus includes (1) a determination unit that determines a store having a target product associated with a user of the portable terminal in stock, and (2) a transmission unit that transmits information determining the determined store to the portable terminal.

The portable terminal includes (1) a judging unit that receives the information transmitted by the transmission unit and judges whether or not a distance between the store determined by the information and the portable terminal is less than or equal to a predetermined distance, and (2) an output control unit that outputs information related to the determined store and the target product in a case where it is judged that the distance between the determined store and the portable terminal is less than or equal to the predetermined distance.

An information processing apparatus of the present invention includes (1) a judging unit that acquires information determining a store having a target product associated with a user of the information processing apparatus in stock, and judging whether or not a distance between the determined store and the information processing apparatus is less than or equal to a predetermined distance, and (2) an output control unit that outputs information related to the determined store and the target product in a case where it is judged that the distance between the determined store and the portable terminal is less than or equal to the predetermined distance.

### Advantageous Effects of Invention

According to the present invention, a technology for increasing opportunities for a user to purchase a product is provided.

### BRIEF DESCRIPTION OF THE DRAWINGS

The above object and other objects, features, and advantages will become more apparent from exemplary example embodiments set forth below and the following drawings appended thereto.

FIG. 1 is a block diagram illustrating an information processing apparatus of Example Embodiment 1.

FIG. 2 is a diagram conceptually illustrating the operation of the information processing apparatus of Example Embodiment 1.

FIG. 3 is a diagram illustrating a computer for implementing the information processing apparatus.

FIG. 4 is a flowchart illustrating a flow of process executed by the information processing apparatus of Example Embodiment 1.

FIG. 5 is a diagram illustrating association between a user and a product in a table format.

FIG. 6 is a diagram illustrating information related to association between a store and a product sold in the store in a table format.

FIG. 7 is a diagram illustrating output information displayed on a display device of a portable terminal of the user.

FIG. 8 is a flowchart illustrating a flow of process executed by an information processing apparatus of a modification example.

FIG. 9 is a block diagram illustrating an information processing apparatus of Example Embodiment 2.

FIG. 10 are diagrams illustrating a method of implementing association between a user group and a target product.

FIG. 11 is a block diagram illustrating an information processing apparatus of Example Embodiment 4.

FIG. 12 is a diagram illustrating information output by a second output control unit 2100 of Example Embodiment 4.

FIG. 13 is a flowchart illustrating a flow of process executed by the information processing apparatus of Example Embodiment 4.

### DESCRIPTION OF EMBODIMENTS

Hereinafter, example embodiments of the present invention will be described using the drawings. Note that in all of the drawings, the same constituents will be designated by the same reference signs, and descriptions of such constituents will not be repeated. In addition, in each block diagram, each block represents a configuration of a function unit and not a configuration of a hardware unit unless otherwise specified.

### Example Embodiment 1

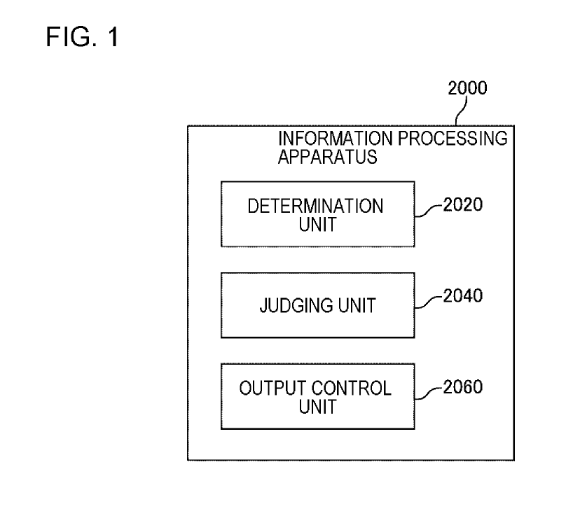

FIG. 1 is a block diagram illustrating an information processing apparatus 2000 of Example Embodiment 1. In a case where a store within a predetermined distance from a portable terminal of a user has a product associated with the user in stock, the information processing apparatus 2000 outputs information related to the store and the product to the portable terminal of the user. To do so, the information processing apparatus 2000 includes a determination unit 2020, a judging unit 2040, and an output control unit 2060.

The determination unit 2020 determines the store that has the product associated with the user in stock. Hereinafter, the product associated with the user will be referred to as a target product. In addition, the store that has the target product in stock will be referred to as a target store.

The judging unit 2040 judges whether or not the distance between the portable terminal of the user and the target store determined by the determination unit 2020 is less than or equal to a predetermined distance. The output control unit 2060 outputs information related to the target store and the target product to the portable terminal of the user, in a case where it is judged that the distance between the portable terminal of the user and the target store is less than or equal to the predetermined distance. Hereinafter, the information output by the output control unit 2060 will be referred to as output information.

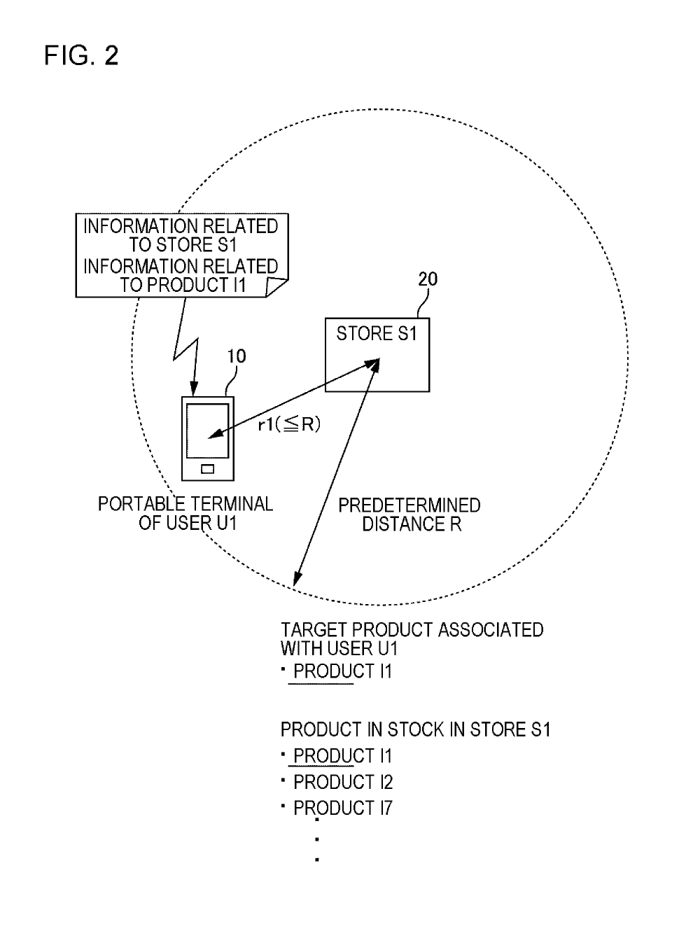

FIG. 2 is a diagram conceptually illustrating the operation of the information processing apparatus 2000 of Example Embodiment 1. In FIG. 2, a product I1 is associated with a user U1. That is, the target product is the product I1. Therefore, the determination unit 2020 determines a store having the product I1 in stock as a target store 20. In the example in FIG. 2, a store S1 has the product I1 in stock. Thus, the store S1 is determined as the target store 20.

The judging unit 2040 judges whether or not a distance r1 between a portable terminal 10 of the user and the store S1 is less than or equal to a predetermined distance R. In FIG. 2, r1 is less than or equal to R. Therefore, the output control unit 2060 outputs information related to the store S1 and information related to the target product I1 to the portable terminal 10 of the user.

### Advantageous Effect

According to the information processing apparatus 2000 of the present example embodiment, the store that has the product associated with the user in stock is determined. Furthermore, in a case where the distance between the store and the portable terminal of the user is within the predetermined distance, information related to the store and the product is output to the portable terminal of the user. Since the store having the product associated with the user in stock is determined by the information processing apparatus 2000, the user does not need to know the store that has the product in stock in advance. Thus, according to the information processing apparatus 2000 of the present example embodiment, the user can recognize the store having the product in stock even in a case where the store having the product associated with the user in stock is not known. In addition, a store that sells the product associated with the user but does not have the product in stock is not handled as the target store 20. Thus, it is unlikely that the user goes to the store selling the product associated with the user, but the product is sold out. Thus, opportunities for the user to purchase the product can be increased.

Hereinafter, the present example embodiment will be described in further detail.

<Hardware Configuration Example of Information Processing Apparatus 2000>

Each functional configuration unit of the information processing apparatus 2000 may be implemented by hardware (example: a hardwired electronic circuit) that implements each functional configuration unit, or may be implemented by a combination of hardware and software (example: a combination of an electronic circuit and a program controlling the electronic circuit). Hereinafter, a case where each functional configuration unit of the information processing apparatus 2000 is implemented by a combination of hardware and software will be further described.

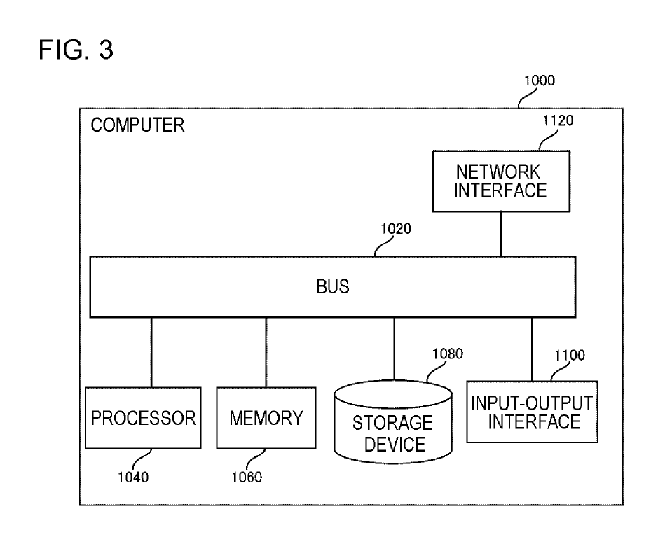

FIG. 3 is a diagram illustrating a computer 1000 for implementing the information processing apparatus 2000. Various computers are used as the computer 1000. For example, the computer 1000 is a personal computer (PC), a server machine, a tablet terminal, a smartphone, or the like. The computer 1000 may be a special-purpose computer designed to implement the information processing apparatus 2000 or may be a general-purpose computer.

The computer 1000 includes a bus 1020, a processor 1040, a memory 1060, a storage device 1080, an input-output interface 1100, and a network interface 1120. The bus 1020 is a data transfer path for the processor 1040, the memory 1060, the storage device 1080, the input-output interface 1100, and the network interface 1120 to transmit and receive data with each other. The processor 1040 is an operation processing apparatus such as a central processing unit (CPU) or a graphics processing unit (GPU). The memory 1060 is a main storage device configured with a random access memory (RAM) or the like. The storage device 1080 is an auxiliary storage device configured with a hard disk, a solid state drive (SSD), a memory card, a read only memory (ROM), or the like. The storage device 1080 may be configured using a RAM or the like.

The input-output interface 1100 is an interface for connecting the computer 1000 and input-output apparatuses. For example, an input apparatus such as a keyboard or a mouse and an output apparatus such as a display device are connected to the input-output interface 1100.

The network interface 1120 is an interface for connecting to a communication network such as a wide area network (WAN) or a local area network (LAN).

The storage device 1080 stores a program module that implements each function of the information processing apparatus 2000. The processor 1040 implements each function corresponding to the program module by reading each program module into the memory 1060 and executing the program module.

<Implementation Example of Information Processing Apparatus 2000>

Various computers may be used as the specific computer 1000 for implementing the information processing apparatus 2000. For example, the computer 1000 is the portable terminal 10 of the user. For example, in this case, the user who desires to use the information processing apparatus 2000 installs an application implementing the function of the information processing apparatus 2000 on the portable terminal 10 and operates the application. Accordingly, the portable terminal 10 of the user functions as the information processing apparatus 2000. Consequently, the user can acquire information related to the target product or information related to the target store using the information processing apparatus 2000.

In another example, for example, the computer 1000 is a server (hereinafter, an external server) that is communicably connected to the portable terminal 10 of the user and a store server. For example, the external server is a server possessed by a third party (for example, a service company) that provides a service using the information processing apparatus 2000 to the user or the store. For example, in this case, an administrator or the like of the external server installs the application implementing the information processing apparatus 2000 on the external server and operates the application. Accordingly, the external server functions as the information processing apparatus 2000. Consequently, the third party can provide a service that matches the need of the user interested in a target product 30 and the need of the store desiring to sell the target product 30 to the user.

In another example, the computer 1000 is a server (hereinafter, a store server) that is installed in each store possibly handled as a target store. For example, in this case, an administrator or the like of the store server installs the application implementing the information processing apparatus 2000 on the store server and operates the application. Accordingly, the store server functions as the information processing apparatus 2000. Consequently, the user who is considered to be interested in the target product 30 in stock in the store can be caused to know that the target product 30 is sold in the store. Thus, opportunities to obtain customers can be increased.

Note that in a case where the computer 1000 is the store server, the determination unit 2020 can be omitted. The store server judges whether or not the product associated with the user is present among the products of the store in stock, and outputs information related to the store and the product to the portable terminal of the user in a case where the distance between the store and the portable terminal of the user associated with the product in stock is less than or equal to the predetermined distance.

Note that the application that is operated in the portable terminal 10 of the user, the store server, or the external server is an application that is configured with the program module stored in the storage device 1080.

The information processing apparatus 2000 may be implemented by a plurality of computers. For example, among the functions of the information processing apparatus 2000, the judging unit 2040 and the output control unit 2060 are implemented by the portable terminal 10 of the user, and the determination unit 2020 is implemented by the store server or the external server. In this case, determination of the target store 20 is performed by the store server or the external server, and information specifying the target store 20 is transmitted to the portable terminal 10 of the user. The portable terminal 10 of the user that receives the information performs a process of the judging unit 2040 and a process of the output control unit 2060 for the target store 20 indicated in the information as a target.

<Flow of Process>

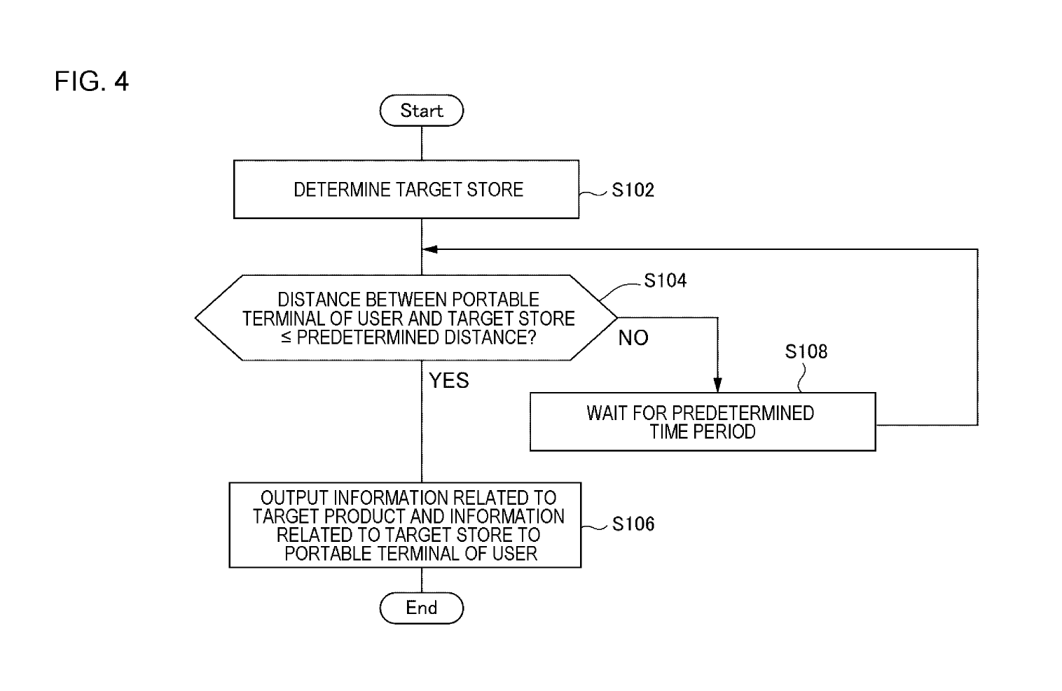

FIG. 4 is a flowchart illustrating a flow of process executed by the information processing apparatus 2000 of Example Embodiment 1. The determination unit 2020 determines the target store 20 (S102). The judging unit 2040 judges whether or not the distance between the portable terminal 10 of the user and the target store 20 is less than or equal to the predetermined distance (S104). In a case where the distance between the portable terminal 10 of the user and the target store 20 is less than or equal to the predetermined distance (S104: YES), the output control unit 2060 outputs the output information to the portable terminal 10 of the user (S106).

In a case where the distance between the portable terminal 10 of the user and the target store 20 is neither less than nor equal to the predetermined distance (S104: NO), the information processing apparatus 2000 waits for a predetermined time period (S108). Then, the information processing apparatus 2000 executes S104 again. By doing so, in a case where the distance between the portable terminal 10 of the user and the target store 20 becomes less than or equal to the predetermined distance as a result of the user moving to approach the target store 20, the output information is output to the portable terminal 10 of the user.

Note that the process that is executed in a case where the distance between the portable terminal 10 of the user and the target store 20 is neither less than nor equal to the predetermined distance (S104: NO) is not limited to the example in FIG. 4. For example, in this case, the process in FIG. 4 may be finished. In this case, for example, the information processing apparatus 2000 executes the processes of S102 to S106 for each predetermined time period.

The predetermined distance and the predetermined time period may be set in advance in the information processing apparatus 2000 or may be stored in a storage device that can be accessed from the information processing apparatus 2000.

<Target Product>

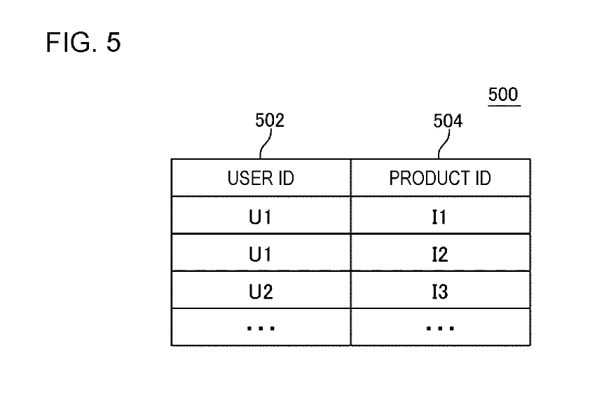

As described above, the target product is a product that is associated with the user. FIG. 5 is a diagram illustrating association between the user and the product in a table format. The table illustrated in FIG. 5 will be referred to as a table 500.

The table 500 includes two columns of a user identifier (ID) 502 and a product ID 504. The user ID 502 indicates an identifier of the user. The product ID 504 indicates an identifier of the product. For example, a record in the first row of the table 500 shows that the product I1 is associated with the user U1.

Note that information related to the product associated with the user ID 502 is not limited to the product ID. For example, information related to the product associated with the user ID 502 may be a product name.

For example, association between the user and the product is manually performed by the user. For example, the user who uses the information processing apparatus 2000 for the first time performs user registration (creation of a user account). At this time, the user registers the user ID. Furthermore, the user registers the target product. For example, the user registers a product of interest as the target product.

Information related to the target product registered by the user may be information that does not uniquely specify the product. For example, the user may register a category of the target product. The category of the product is any information that represents a classification of the product such as food, beverage, cleaning products, cleansing products, meat, lunch, tea, detergent, or shampoo. By doing so, the user is associated with the category of the product. In this case, all products belonging to the category are substantially associated with the user.

A method of associating the user with the product is not limited to a method in which the user performs manual registration. Other methods will be described in other example embodiments described below.

The table 500 is stored in advance in any storage device. The storage device in which the table 500 is stored may be a storage device (for example, the storage device 1080) disposed inside the computer 1000 implementing the information processing apparatus 2000 or may be a storage device disposed outside the information processing apparatus 2000.

Note that in a case where the table 500 is stored inside the portable terminal 10 of the user, the portable terminal 10 of the user may show only the target product associated with the user. In this case, the table 500 may not include the user ID 502.

<Determination of Target Store: S102>

The determination unit 2020 determines the (target store 20) that has the target product 30 in stock (S102). To do so, first, the determination unit 2020 acquires the user ID of the user who is using the information processing apparatus 2000. The information processing apparatus 2000 acquires the product ID of the product associated with the user ID in the table 500. Accordingly, the determination unit 2020 determines the product (target product 30) associated with the user.

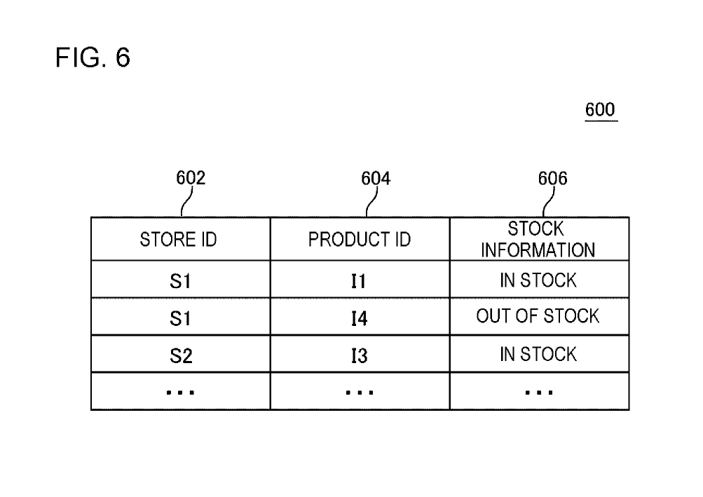

For example, the determination unit 2020 determines the target store 20 using information related to association between the store and the product sold in the store. FIG. 6 is a diagram illustrating the information related to association between the store and the product sold in the store in a table format. The table in FIG. 6 will be referred to as a table 600.

The table 600 includes two columns of a store ID 602, a product ID 604, and stock information 606. The store ID 602 indicates an identifier of the store. The product ID 604 indicates the identifier of the product. The stock information 606 indicates whether or not the product is in stock. For example, in the table 600, a record in the first row shows that the store S1 has the product I1 in stock.

For example, the stock information 606 that is related to the product of a certain store is updated by the store server that manages the product of the store. In another example, a database for managing the stock of the product of the store may be configured to be in synchronization with the table 600.

The table 600 is stored in any storage device. The storage device in which the table 600 is stored may be a storage device (for example, the storage device 1080) disposed inside the computer 1000 implementing the information processing apparatus 2000 or may be a storage device disposed outside the information processing apparatus 2000.

Note that in a case where the table 600 is stored in a storage device (for example, a storage device disposed inside the store server) disposed in each store, the table 600 may show only information related to the product sold in the store. In this case, the table 600 may not include the store ID 602.

<Judging of Distance: S104>

The judging unit 2040 judges whether or not the distance between the portable terminal 10 of the user and the target store 20 is less than or equal to the predetermined distance (S104). Specifically, the judging unit 2040 performs the judging by computing the distance between the portable terminal 10 of the user and the target store 20 and comparing the computed distance with the predetermined distance.

To perform the judging, the position of the portable terminal 10 of the user and the position of the target store 20 need to be determined. Hereinafter, a determination method for each of the positions will be illustrated.

<<Method of Determining Position of Portable Terminal 10>>

The position of the portable terminal 10 of the user can be determined using, for example, a global positioning system (GPS) sensor that is disposed in the portable terminal 10 of the user. The information processing apparatus 2000 determines the position of the portable terminal 10 of the user by acquiring information (hereinafter, positional information) that indicates the position of the portable terminal 10 of the user determined by the GPS sensor or the like. In the case of using the GPS sensor, the positional information indicates, for example, GPS coordinates.

In a case where the information processing apparatus 2000 is implemented by the portable terminal 10 of the user, for example, the judging unit 2040 directly acquires the positional information stored inside the portable terminal 10 of the user. On the other hand, in a case where the information processing apparatus 2000 is implemented by an apparatus other than the portable terminal 10 of the user, for example, the judging unit 2040 receives the positional information transmitted by the portable terminal 10 of the user. Note that a technology for determining the position of the portable terminal using the GPS sensor or the like and a technology for acquiring the positional information related to the portable terminal from the portable terminal can use well-known technologies.

<<Method of Determining Position of Target Store 20>>

The position of the target store 20 can be determined using, for example, a GPS sensor that is installed in the target store 20, or map data that includes the target store 20. In a case where the information processing apparatus 2000 is implemented by the store server installed in the target store 20, for example, the judging unit 2040 acquires positional information related to the target store 20 from the storage device (for example, the storage device disposed inside the store server) installed in the target store 20. In this case, the positional information related to the target store 20 is stored in advance in the storage device.

On the other hand, in a case where the information processing apparatus 2000 is implemented by an apparatus other than the store server, for example, the judging unit 2040 acquires the positional information related to the target store 20 from the store server of the target store 20. In another example, information related to association between the store and the positional information related to the store may be stored in advance in a storage device that can be accessed from the information processing apparatus 2000. In this case, the judging unit 2040 acquires the positional information associated with the target store 20 from the storage device.

<<Case where Judging by Judging Unit 2040 is Repeatedly Executed>>

As illustrated in the flowchart in FIG. 4, for example, the information processing apparatus 2000 repeatedly executes the judging in S104. At this time, the judging unit 2040 acquires the positional information related to the portable terminal 10 of the user, for each execution of S104 is executed. On the other hand, the positional information related to the target store 20 that is once acquired can be repeatedly used, except for a case where the target store 20 is a moving store (for example, a stall).

<Output of Output Information: S106>

In a case where the distance between the portable terminal 10 of the user and the target store 20 is less than or equal to the predetermined distance (S104: YES), the output control unit 2060 outputs the output information (information related to the target store 20 and information related to the target product 30) to the portable terminal 10 of the user (S106). Information related to the target store 20 in the output information includes, for example, the name or the positional information (for example, an address or a position on a map) related to the target store 20. Information related to the target product 30 in the output information includes, for example, the product name or the price of the target product 30.

There are various methods of outputting the output information to the portable terminal 10 of the user from the information processing apparatus 2000. In a case where the information processing apparatus 2000 is implemented by the portable terminal 10 of the user, for example, the information processing apparatus 2000 displays the output information on a display device of the portable terminal 10 of the user.

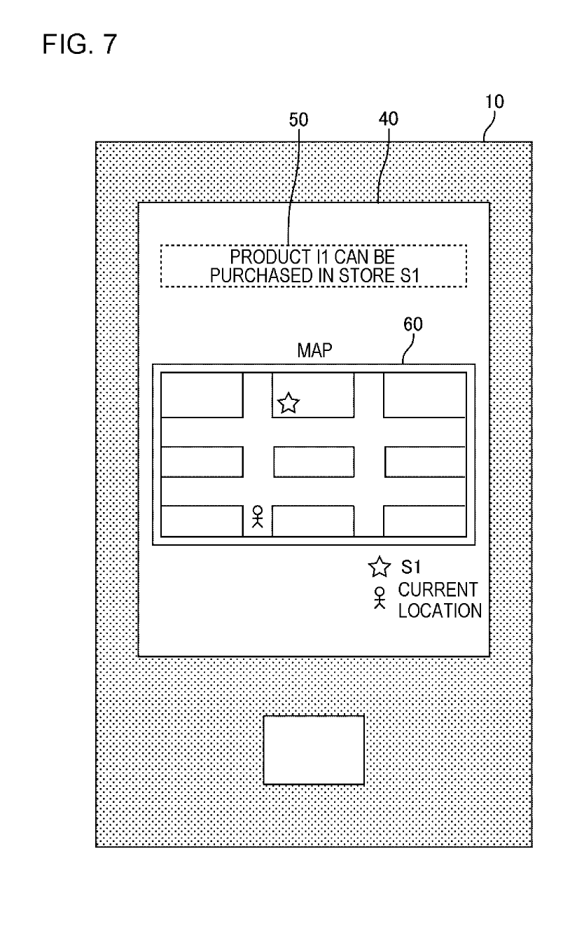

FIG. 7 is a diagram illustrating the output information displayed on the display device of the portable terminal 10 of the user. A display device 40 is a display device that is disposed in the portable terminal 10 of the user. In the example in FIG. 7, the target store 20 is the store S1, and the target product 30 is the product I1.

The display device 40 displays a message 50 and a map 60. The message 50 is a message that represents that the store S1 has the product I1 in stock. The map 60 is a map in which the current location of the user of the portable terminal 10 and the position of the store S1 are illustrated. By viewing the display device 40, the user can recognize that the product I1 can be purchased in the store S1 and a way to go to the store S1.

In a case where the information processing apparatus 2000 is implemented by an apparatus other than the portable terminal 10 of the user, for example, the information processing apparatus 2000 transmits the output information to a destination represented by a mail address of the use. For example, the mail address of the user is registered in a case where the user account is registered. In another example, the information processing apparatus 2000 may send the output information by push notification to a predetermined application that is being operated on the portable terminal 10 of the user. In this case, the user who desires to use the information processing apparatus 2000 operates the predetermined application in the portable terminal 10. Note that a technology for sending information by push notification to the application being operated on the portable terminal can use well-known technologies.

### Modification Example

According to the information processing apparatus 2000 of Example Embodiment 1, in a case where the store that is within the predetermined distance from the portable terminal 10 of the user has the target product 30 associated with the user in stock, information related to the store (target store 20) and the target product 30 is output to the portable terminal 10 of the user. However, a configuration of the information processing apparatus 2000 having such a function is not limited to the above configuration. Hereinafter, another configuration example of the information processing apparatus 2000 implementing the function will be illustrated as a modification example of the information processing apparatus 2000 of Example Embodiment 1.

The determination unit 2020 of the modification example determines the store within the predetermined distance from the portable terminal 10 of the user. At this timing, a determination as to whether or not each store has the target product 30 in stock is not performed.

Next, the judging unit 2040 of the modification example judges whether or not the target product 30 is included in the products in stock in the determined store. In a case where the target product 30 is included in the products in stock in the determined store, the output control unit 2060 of the modification example outputs information related to the store and information related to the target product 30 to the portable terminal 10 of the user.

As described above, the determination unit 2020 of the modification example determines the store within the predetermined distance from the portable terminal 10 of the user. For example, the determination unit 2020 of the modification example searches a table showing association between the store ID and the positional information related to the store determined by the store ID on a condition that the positional information within the predetermined distance from the portable terminal 10 of the user is shown. By doing so, the determination unit 2020 acquires the store ID of the store within the predetermined distance from the portable terminal 10 of the user.

The judging unit 2040 of the modification example searches the table 600 for a record that matches a condition that, for example, “the store ID acquired by the determination unit 2020 is shown in the store ID 602, the product ID of the target product 30 is shown in the product ID 604, and the stock information 606 indicates that the product is in stock”. In a case where a record that matches the condition is present, the target product 30 is included in the products in stock in the store determined by the store ID. Therefore, the output control unit 2060 outputs information related to the store determined by the store ID used in the search and information related to the target product 30 to the portable terminal 10 of the user. Note that in a case where a plurality of store IDs are acquired by the determination unit 2020, the judging unit 2040 performs the search for each acquired store ID.

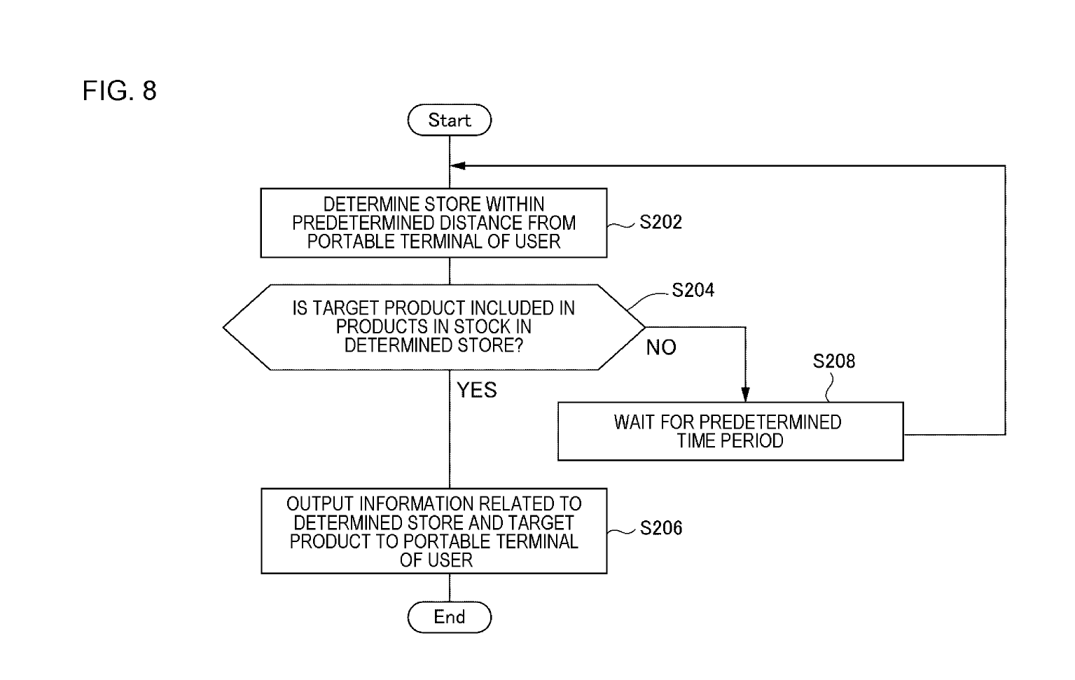

FIG. 8 is a flowchart illustrating a flow of process executed by the information processing apparatus 2000 of the modification example. The determination unit 2020 determines the store within the predetermined distance from the portable terminal 10 of the user (S202). The judging unit 2040 judges whether or not the target product 30 is included in the products in stock in the determined store (S204). In a case where the target product 30 is included in the products in stock in the determined store (S204: YES), the output control unit 2060 outputs the output information to the portable terminal 10 of the user (S206).

On the other hand, in a case where the target product 30 is not included in the products in stock in the determined store (S204: NO), the information processing apparatus 2000 waits for a predetermined time period (S208) and executes S202 again. In a case where the user moves, the store determined in S202 (the store within the predetermined distance from the portable terminal 10 of the user) changes. Thus, by repeatedly executing S202, there is a possibility that the store determined in S202 (the store within the predetermined distance from the portable terminal 10 of the user) is changed to the store having the target product in stock.

According to the information processing apparatus 2000 of the present modification example, the same effect as the information processing apparatus 2000 of Example Embodiment 1 can be achieved.

The information processing apparatus 2000 of each example embodiment described below may have the function of the information processing apparatus 2000 of the modification example described here instead of having the function of the information processing apparatus 2000 of Example Embodiment 1.

### Example Embodiment 2

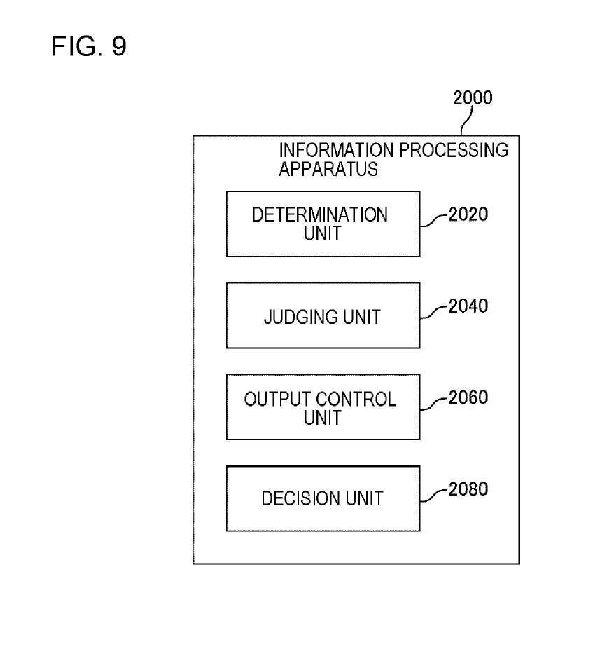

FIG. 9 is a block diagram illustrating the information processing apparatus 2000 of Example Embodiment 2. The information processing apparatus 2000 of Example Embodiment 2 is the same as the information processing apparatus 2000 of Example Embodiment 1 except for the points described below.

The information processing apparatus 2000 of Example Embodiment 2 includes a decision unit 2080. The decision unit 2080 decides the target product 30 to be associated with the user using a behavior history of the user. The decision unit 2080 stores association between the decided target product 30 and the user in a storage device. For example, in a case where association between the user and the target product 30 is shown in the table 500, the decision unit 2080 adds a record showing association between the decided target product 30 and the user to the table 500.

Information that indicates the behavior history of the user (hereinafter, behavior history information) is stored in advance in any storage device. Hereinafter, this storage device will be considered as, for example, a database that manages the behavior history information.

The behavior history information indicates various types of information. For example, the behavior history information indicates a history of web pages browsed in the past by the user. In another example, the behavior history information indicates a history of products browsed in the past by the user in the store. In another example, the behavior history information indicates a history of conversation of the user in the past.

Hereinafter, a method of generating the various types of behavior history information illustrated above and a method of deciding the target product to be associated with the user using the behavior history information will be illustrated.

<Browsing History of Web Pages>

The behavior history information that indicates the browsing history of web pages is, for example, a browsing history of a browser application of the portable terminal 10 of the user. In this case, the decision unit 2080 acquires the browsing history of the browser application of the portable terminal 10 of the user as the behavior history information.

Furthermore, in this case, the decision unit 2080 decides the product to be associated with the user using the browsing history of the browser application of the portable terminal 10 of the user. For example, the decision unit 2080 acquires a web page determined by each unified resource locator (URL) shown in the browsing history of the browser application. In a case where the web page is a page that shows information related to the product (for example, a page of the product of a shopping site), the decision unit 2080 extracts information specifying the product (for example, a product name) from the web page.

A determination as to whether or not a certain web page is a page showing information related to the product can be performed by analyzing, for example, a source file of the web page. For example, a plurality of keywords that are estimated to be included in the page showing information related to the product are set in advance. In a case where a predetermined number of keywords or more among the plurality of keywords are included in the source file of the acquired web page, the decision unit 2080 judges that the web page is the page related to the product. The keyword is a keyword such as a product name, a price, a model number, or a brand.

The decision unit 2080 associates a part or all of the products extracted from the web page included in the browsing history with the user. There are various methods of deciding the product to be associated with the user from the extracted products. For example, the decision unit 2080 associates a product that is browsed a large number of times with the user (for example, a product extracted from a predetermined number or more of browsing histories). In another example, the decision unit 2080 associates a product that is not included in a purchase history of the user among the extracted products with the user. In this case, the decision unit 2080 acquires the history of products purchased in the past by the user. The purchase history of the user in the store or the purchase history of the user on the shopping site can be used as the history of products purchased in the past by the user. For example, these purchase histories are stored in advance in a storage device that can be accessed from the information processing apparatus 2000.

The decision unit 2080 may use any method of acquiring the browsing history of web pages. In a case where the information processing apparatus 2000 is implemented as the portable terminal 10 of the user, for example, the information processing apparatus 2000 directly acquires the browsing history of web pages from a storage device disposed in the portable terminal 10 of the user. On the other hand, in a case where the information processing apparatus 2000 is implemented by an apparatus other than the portable terminal 10 of the user, for example, the information processing apparatus 2000 acquires the browsing history of web pages from the portable terminal 10 of the user by requesting the portable terminal 10 of the user to transmit the browsing history of web pages.

<History of Products Browsed by User In Store>

For example, the history of products browsed in the past by the user in the store can be generated by analyzing a video of the user captured by a camera that is installed in the store. The product browsed by the user is, for example, a product held in hand by the user or a product toward which the eye sight of the user is directed. A technology for determining the product browsed by the user using the video in which the user is captured can use well-known technologies.

The decision unit 2080 associates a part or all of the products included in the history of products browsed by the user in the store with the user. A method of deciding the product to be associated with the user from the products included in the history of products browsed by the user in the store is the same as the method of deciding the product to be associated with the user from the products extracted from the browsing history of web pages.

<History of Conversation of User in Store>

For example, conversation of the user in the store is recorded using a microphone that is installed in a shopping basket or a cart used by the user. Voice data of the recorded conversation is stored in any storage device in association with information that specifies the user. For example, in a case where the user pays for the product in the store using a membership card or a point card, the voice data is stored in association with an ID of the user that is acquired from the membership card or the point card. For example, the history of conversation of the user in the store is managed by the store server in the store.

The decision unit 2080 acquires the voice data in which conversation of the user in the store is recorded as the history of conversation of the user in the store. Furthermore, the decision unit 2080 extracts information specifying the product (for example, the name of the product) from the voice data by analyzing the voice data. The decision unit 2080 associates a part or all of the extracted products with the user. A method of deciding the product to be associated with the user from the products extracted from the history of conversation of the user is the same as the method of deciding the product to be associated with the user from the products extracted from the browsing history of web pages.

Note that the history of conversation of the user acquired by the decision unit 2080 is not limited to voice data. For example, the decision unit 2080 may acquire text data that represents the history of conversation of the user. The text data can be generated by performing a voice recognition process for the voice data in which conversation of the user is recorded. For example, the text data is generated by the store server in the store in which conversation of the user is recorded.

The decision unit 2080 acquires the history of conversation of the user from a storage device in which the history of conversation of the user is stored. For example, this storage device is disposed in the store server. In another example, the storage device may be a storage device of the external server that collects and manages the history of conversation of the user from a plurality of store servers.

### Hardware Configuration Example

For example, a hardware configuration of a computer that implements the information processing apparatus 2000 of Example Embodiment 2 is represented by FIG. 3 in the same manner as Example Embodiment 1. However, the storage device 1080 of the computer 1000 implementing the information processing apparatus 2000 of the present example embodiment further stores a program module that implements the function of the information processing apparatus 2000 of the present example embodiment.

### Advantageous Effect

According to the information processing apparatus 2000 of Example Embodiment 2, the product to be associated with the user is decided based on the behavior history of the user. Thus, the product to be associated with the user may not be decided by the user. Thus, the effort of the user using the information processing apparatus 2000 can be reduced.

In addition, by using the behavior history of the user, the product can be associated with the user by considering even the potential needs of the user that the user is not aware of. Thus, from the viewpoint of the user, there is an advantage such that opportunities to purchase the product matching the interest of the user increases. Furthermore, from the viewpoint of a seller of the product, there is an advantage such that opportunities to obtain customers increases.

### Example Embodiment 3

The information processing apparatus 2000 of Example Embodiment 3 is represented in FIG. 1 in the same manner as the information processing apparatus 2000 of Example Embodiment 1 or is represented in FIG. 9 in the same manner as the information processing apparatus 2000 of Example Embodiment 2. The information processing apparatus 2000 of Example Embodiment 3 is the same as the information processing apparatus 2000 of Example Embodiment 1 or the information processing apparatus 2000 of Example Embodiment 2 except for the points described below.

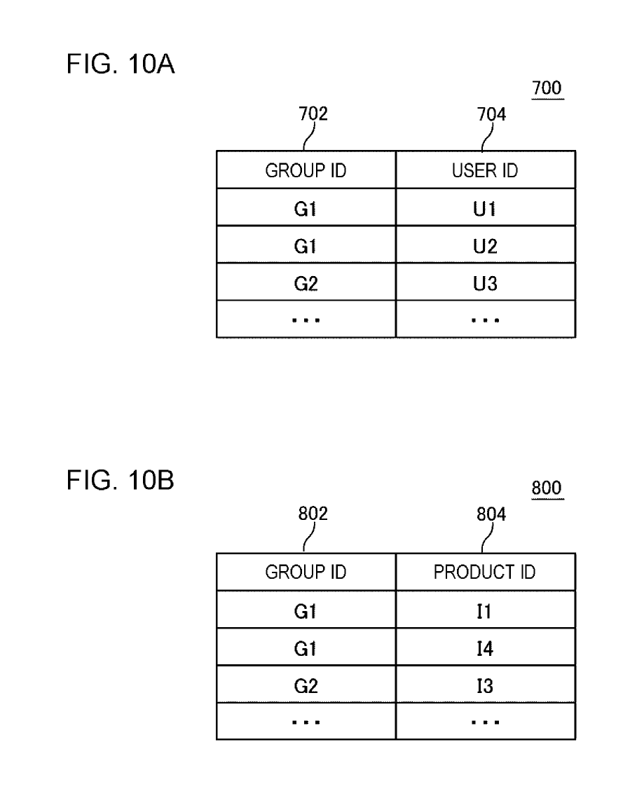

In the information processing apparatus 2000 of Example Embodiment 3, the target product 30 is associated with a group to which one or a plurality of users belong. FIG. 10 are diagrams illustrating a method of implementing association between a user group and the target product 30. A table in FIG. 10A is a table 700 in which the user group is associated with the user who belongs to the group. The table 700 includes a group ID 702 and a user ID 704. The group ID 702 indicates an identifier of the user group. The user ID 704 indicates an identifier of the user who belongs to the group specified by the group ID 702. In the example in FIG. 10A, the user U1 and a user U2 belong to the same group G1.

A table in FIG. 10B is a table 800 in which the user group is associated with the target product 30. The table 800 includes a group ID 802 and a product ID 804. The group ID 802 indicates an identifier of the user group. The product ID 804 indicates an identifier of the target product 30 that is associated with the group specified by the group ID 802. For example, in the example in FIG. 10B, products I1 and I4 are associated with the group G1.

The determination unit 2020 of Example Embodiment 3 determines a store having the target product 30 associated with the group in stock as the target store 20. The judging unit 2040 of Example Embodiment 3 computes the distance between the determined target store 20 and the portable terminal 10 of each user included in the group and compares the computed distance with the predetermined distance. By doing so, the judging unit 2040 of Example Embodiment 3 judges whether or not the portable terminal 10 whose distance to the target store 20 is less than or equal to the predetermined distance is present among the portable terminals 10 of the users included in the group. The output control unit 2060 of Example Embodiment 3 outputs the output information to the portable terminal 10 whose distance to the target store 20 is less than or equal to the predetermined distance.

For example, users U1, U2, and U3 belong to the group G1. Furthermore, the store S1 has the product I1 associated with the group G1 in stock. The distance between the portable terminal 10 of the user U1 and the store S1 is less than or equal to the predetermined distance. The distance between the portable terminal 10 of the user U2 and the store S1 is less than or equal to the predetermined distance. The distance between the portable terminal 10 of the user U3 and the store S1 is greater than the predetermined distance. In this case, the output control unit 2060 outputs the output information to the portable terminal 10 of the user U1 and the portable terminal 10 of the user U2. On the other hand, the output information is not output to the portable terminal 10 of the user U3.

<Process of Associating Group with Target Product 30>

Association between the group and the target product 30 may be performed by the user or may be performed by the information processing apparatus 2000. In the former case, the user who belongs to the group associates the group with the target product 30 in the same method as the method in which the user manually associates the user with the target product 30 (the method described in Example Embodiment 1).

In a case where association between the group and the target product 30 is performed by the information processing apparatus 2000, the decision unit 2080 described in Example Embodiment 2 decides the target product 30 to be associated with the group. The decision unit 2080 decides the target product 30 to be associated with the group using the behavior history information related to each user included in the group.

For example, the decision unit 2080 decides the product to be associated with each user included in the group using any method described in Example Embodiment 2. Furthermore, for example, the decision unit 2080 associates the product, which is associated with any one or more users, with the group to which those users belong to. In another example, the decision unit 2080 associates the product, which is associated with a predetermined number or more of users included in the same group, with that group. In another example, the decision unit 2080 associates the product, which is associated with all users included in the same group, with the group to which those users belong to. Note that in these methods, the decision unit 2080 may associate the product with only the group and may not associate the product with each user.

The predetermined number may be set in advance in the decision unit 2080 or may be stored in a storage device that can be accessed from the decision unit 2080.

### Hardware Configuration Example

For example, a hardware configuration of a computer that implements the information processing apparatus 2000 of Example Embodiment 3 is represented by FIG. 3 in the same manner as Example Embodiment 1. However, the storage device 1080 of the computer 1000 implementing the information processing apparatus 2000 of the present example embodiment further stores a program module that implements the function of the information processing apparatus 2000 of the present example embodiment.

### Advantageous Effect

According to the information processing apparatus 2000 of the present example embodiment, the product is associated with the group to which a plurality of users belong. By doing so, in a case where a user approaches a store that has a product of no interest for the user but of interest for another user belonging to the same group, the user can recognize information related to the product and information related to the store. Thus, for example, it is easy for the user to buy a product desired by another user belonging to the same group on his behalf. In another example, by associating a product desired by each user as a birthday present with the group, each user can easily buy and present a product desired by another user as a birthday present. Thus, according to the present example embodiment, the convenience of use of the information processing apparatus 2000 by the user is improved.

### Example Embodiment 4

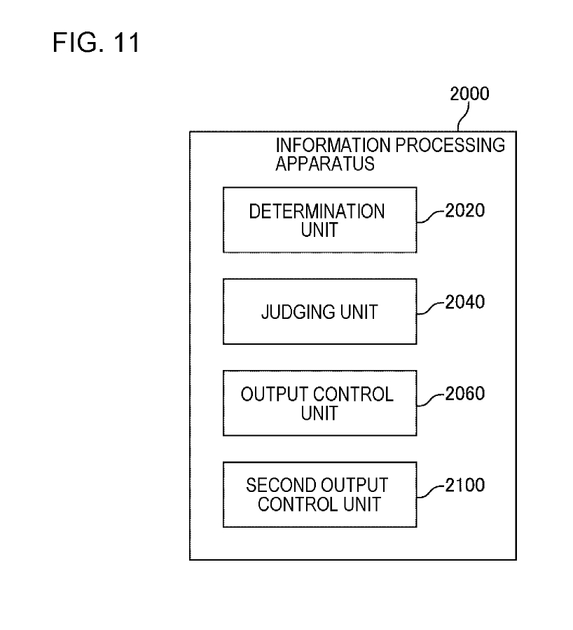

FIG. 11 is a block diagram illustrating the information processing apparatus 2000 of Example Embodiment 4. The information processing apparatus 2000 in FIG. 11 includes a second output control unit 2100.

The second output control unit 2100 outputs information related to a second product that is different from a first product purchased by the user. The information related to the second product includes information that determines a selling area of the second product. In addition, the first product and the second product are sold at different selling areas in the same store.

The operation of the information processing apparatus 2000 of Example Embodiment 4 will be illustrated. The information processing apparatus 2000 is a register terminal R that is installed in a selling area on the first floor of the store (hereinafter, a selling area X). In addition, a product A is sold at the selling area X.

The user who purchases the product A brings the product A to the register terminal R installed at the selling area X, and purchases the product A by paying the price of the product A. The second output control unit 2100 outputs information related to a product B (for example, the product name of the product B) that is different from the product A. The product B is a product that is sold at a selling area Y different from the selling area X. A specific method of deciding which product is to be set as the product B (second product) will be described below.

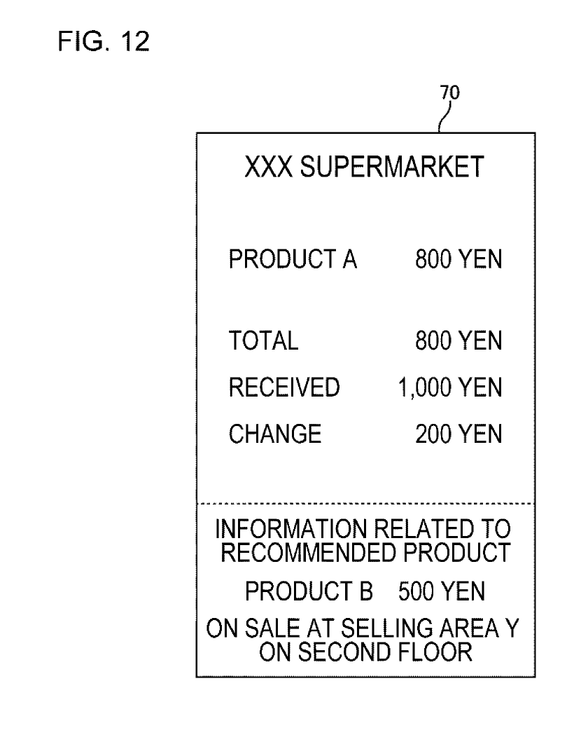

FIG. 12 is a diagram illustrating information output by the second output control unit 2100 of Example Embodiment 4. In FIG. 12, information output by the second output control unit 2100 is printed on a receipt 70 passed to the user who purchases the product A. Information related to the product B printed on the receipt 70 includes information that specifies the selling area Y. Specifically, the receipt 70 shows the name and the price of the product B and also shows that the product B is sold at the selling area Y disposed on the second floor of the store.

### Advantageous Effect

According to the information processing apparatus 2000 of the present example embodiment, the user who purchases a product at a certain selling area of the store is provided with information related to another product sold at another selling area and information related to a product at which the product is sold. By doing so, opportunities to purchase the product or the like of interest can be given to the user. In addition, the user can easily purchase the product or the like of interest. In addition, for the seller of the product, opportunities to obtain customers can be increased, or the sales of the store can be increased.

Hereinafter, the information processing apparatus 2000 of the present example embodiment will be described in further detail.

### Hardware Configuration Example

For example, the information processing apparatus 2000 of Example Embodiment 4 is represented using FIG. 3 in the same manner as the information processing apparatus 2000 of Example Embodiment 1. However, the storage device 1080 of the computer 1000 implementing the information processing apparatus 2000 of Example Embodiment 4 further stores a program module for implementing the function of the information processing apparatus 2000 of Example Embodiment 4.

<Flow of Process>

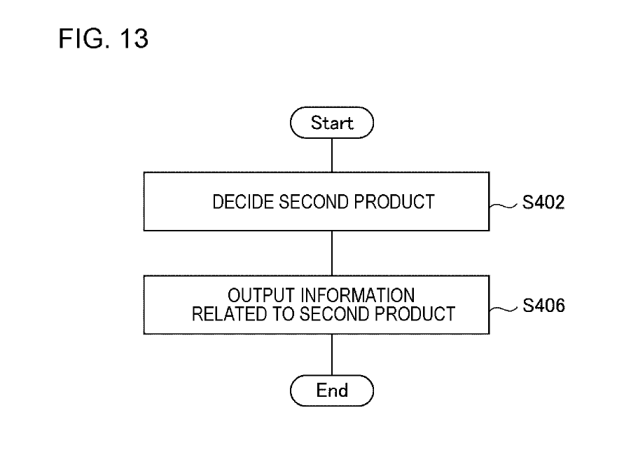

FIG. 13 is a flowchart illustrating a flow of process executed by the information processing apparatus 2000 of Example Embodiment 4. The second output control unit 2100 decides which product is to be set as the second product (S402). The second output control unit 2100 outputs information related to the decided second product (S404).

<Implementation Example of Information Processing Apparatus 2000>

For example, the information processing apparatus 2000 is implemented as a payment apparatus that performs a payment process for the product in a case where the user purchases the first product. The payment apparatus may further have a function of a product registration apparatus. In another example, the information processing apparatus 2000 may be implemented as a store server that is communicably connected to the register terminal in the store in which the first product and the second product are sold, or an external server that is disposed outside the store.

<Decision of Second Product: S402>

The second output control unit 2100 decides which product is to be set as the second product. There are various methods. For example, the second output control unit 2100 decides the product to be set as the second product from products associated with the user who purchases the first product. In another example, the second output control unit 2100 decides the product to be set as the second product from products correlating with the first product. Hereinafter, each of these two methods will be described.

<<Product Associated with User>>

As the second product, the second output control unit 2100 sets a product that satisfies a condition that “the product, which is associated in advance with the user who purchases the first product, is sold in the same store as the first product and is sold at a different selling area from the first product”. A method of associating the user with the product can use the method described in Example Embodiment 1 to Example Embodiment 3.

In order to determine the product associated with the user, the second output control unit 2100 acquires information that specifies the user. For example, the information that specifies the user can be acquired from the point card or the membership card possessed by the user. The second output control unit 2100 acquires the product ID of the product associated with the user by searching the table 500 using the information determining the user. Furthermore, the second output control unit 2100 searches a database that manages information related to products (hereinafter, a product database), using the determined product ID. Accordingly, the second output control unit 2100 acquires information related to the product specified by the product ID.

By using the acquired information, the second output control unit 2100 determines a product that is sold in the same store as the first product and is sold at a different selling area from the first product among the products associated with the user. The second output control unit 2100 sets the determined product as the second product.

<Product Correlating with First Product>

As the second product, the second output control unit 2100 sets a product that satisfies a condition that “the product correlates with the first product purchased by the user, is sold in the same store as the first product, and is sold at a different selling area from the first product”. The first product and the second product may be in any relationship. For example, the second product is a product that is correlated with the first product in advance. For example, this correlation is stored in advance in the product database that manages information related to products. For example, the second product is correlated in advance with a product that is highly likely to be desired by the user purchasing the first product.

In another example, the second product may be a product that belongs to a category of the product correlated in advance with the first product.

As an assumption for determining the second product correlating with the first product, the second output control unit 2100 acquires information that specifies (for example, a product ID of the first product) the first product. For example, the product ID of the first product is acquired in a case where the payment process is performed for the first product. For example, in a case where a barcode is attached to the first product, the ID of the first product is read by a barcode scanner. The second output control unit 2100 acquires information related to the first product and information related to the second product by searching the product database with the acquired information (for example, the product ID) as a key.

<<Case where Plurality of Product Candidates are Present for Second Product>>

In a case where a plurality of products are associated with the user, or a case where a plurality of products correlate with the first product, the second output control unit 2100 may handle all of the plurality of products as the second product or may handle a part of the plurality of products as the second product. In the latter case, for example, the second output control unit 2100 randomly determines a product from the plurality of products and sets the determined product as the second product. In another example, the second output control unit 2100 determines a product having high priority among the plurality of products (for example, a high selling product) and sets the determined product as the second product.

<Output of Information Related to Second Product: S408>

The second output control unit 2100 outputs information related to the second product (S408). Information related to the second product is stored in the product database. Note that information related to the second product stored in the product database includes at least information that specifies the selling area of the second product (for example, information that indicates the floor on which the selling area is disposed or the name of the selling area).

There are various methods for the second output control unit 2100 to output information related to the second product. For example, the second output control unit 2100 outputs information related to the second product on the receipt that is passed to the user purchasing the first product. In another example, the second output control unit 2100 displays information related to the second product on a display device that can be browsed by the user. In another example, the second output control unit 2100 may transmit information related to the second product to the portable terminal carried by the user purchasing the first product.

Note that the second output control unit 2100 may output information related to the second product only in a case where the second product is in stock. In this case, for example, the second output control unit 2100 confirms whether or not the second product determined using the above method is in stock by accessing a database that manages the status of the stock of products. Information related to the second product is output only in a case where the second product is in stock.

While example embodiments of the present invention have been described thus far with reference to the drawings, the example embodiments are illustrations of the present invention, and combinations of the example embodiments or various configurations other than those described above can be employed.

This application claims the benefit of priority from Japanese Patent Application No. 2016-194099 filed on Sep. 30, 2016, the entire disclosure of which is incorporated herein.

1. An information processing method executed by a computer, comprising:
determining a store having a target product associated with a first user in stock;
judging whether or not a distance between a portable terminal of the first user and the determined store is less than or equal to a predetermined distance; and
outputting information related to the determined store and the target product in a case where it is judged that the distance between the portable terminal of the first user and the determined store is less than or equal to the predetermined distance, the information being output to the portable terminal of the first user.

2. An information processing method executed by a computer, comprising:
determining a store within a predetermined distance from a portable terminal of a first user;
judging whether or not a target product that is associated with the first user is included in products in stock in the determined store; and
outputting information related to the determined store and the target product in a case where it is judged that the target product is included in the products in stock in the determined store, the information being output to the portable terminal of the first user.

3. The information processing method according to claim 1,
wherein the target product is associated with a group to which a plurality of users belong, and
the information processing method further comprises outputting the information related to the store and the information related to the target product associated with the group to which the first user belongs in a case where the distance between the store having the target product in stock and the portable terminal of the first user is less than or equal to the predetermined distance, the information being output to the portable terminal of the first user.

4. The information processing method according to claim 1, further comprising deciding the target product to be associated with the first user using a behavior history of the first user.

5. The information processing method according to claim 4, wherein the behavior history of the first user is a history of web pages browsed by the first user, a history of products browsed by the first user, or a history of conversion of the first user.

6. An information processing method comprising outputting information related to a second product different from a first product to a user who purchased the first product,
wherein the information related to the second product includes information specifying a selling area of the second product, and
the first product and the second product are sold at different selling areas in the same store.

7. The information processing method according to claim 6, wherein the information related to the second product and information related to the selling area of the second product are output on a receipt.

8. A non-transitory computer-readable storage medium storing a program causing a computer to execute:
acquiring determination information determining a store having a target product associated with a first user in stock, and judging whether or not a distance between a portable terminal of the first user and the determined store is less than or equal to a predetermined distance; and
outputting information related to the determined store and the target product in a case where it is judged that the distance between the portable terminal of the first user and the determined store is less than or equal to the predetermined distance, the information being output to the portable terminal of the first user.

9. A non-transitory computer-readable storage medium storing a program causing a computer to execute:
determining a store within a predetermined distance from a portable terminal of a first user;
judging whether or not a target product that is associated with the first user is included in products in stock in the determined store; and
outputting information related to the determined store and the target product in a case where it is judged that the target product is included in the products in stock in the determined store, the information being output to the portable terminal of the first user.

10. The medium according to claim 8,
wherein the target product is associated with a group to which a plurality of users belong, and
the program causes the computer to further execute outputting the information related to the store and the information related to the target product associated with the group to which the first user belongs in a case where the distance between the store having the target product in stock and the portable terminal of the first user is less than or equal to the predetermined distance, the information being output to the portable terminal of the first user.

11. The medium according to claim 8, causing the computer to further execute deciding the target product to be associated with the first user using a behavior history of the first user.

12. The medium according to claim 11, wherein the behavior history of the first user is a history of web pages browsed by the first user, a history of products browsed by the first user, or a history of conversion of the first user.

13. A non-transitory computer-readable storage medium storing a program causing a computer to execute:
outputting information related to a second product different from a first product to a user who purchased the first product,
wherein the information related to the second product includes information specifying a selling area of the second product, and
the first product and the second product are sold at different selling areas in the same store.

14. The medium according to claim 13, wherein the information related to the second product and information related to the selling area of the second product are output on a receipt.

15. An information processing system comprising:
a server apparatus; and
a portable terminal,
wherein the server apparatus includes:
a determination unit that determines a store having a target product associated with a user of the portable terminal in stock, and
a transmission unit that transmits information specifying the determined store to the portable terminal, and
the portable terminal includes:
a judging unit that receives the information transmitted by the transmission unit and judges whether or not a distance between the store determined by the information and the portable terminal is less than or equal to a predetermined distance, and
an output control unit that outputs information related to the determined store and the target product in a case where it is judged that the distance between the determined store and the portable terminal is less than or equal to the predetermined distance.

16. An information processing apparatus comprising:
a judging unit that acquires information determining a store having a target product associated with a user of the information processing apparatus in stock, and judges whether or not a distance between the determined store and the information processing apparatus is less than or equal to a predetermined distance; and
an output control unit that outputs information related to the determined store and the target product in a case where it is judged that the distance between the determined store and the information processing apparatus is less than or equal to the predetermined distance.

17. An information processing apparatus comprising:
a judging unit that judges whether or not a target product that is associated with a user of the information processing apparatus is included in products in stock in a store within a predetermined distance from the information processing apparatus; and
an output control unit that outputs information related to the store and the target product in a case where it is judged that the target product is included in the products in stock in the store.

18. The information processing apparatus according to claim 16,
wherein the target product is associated with a group to which a plurality of users belong, and
the output control unit outputs the information related to the store and the information related to the target product associated with the group to which the user of the information processing apparatus belongs in a case where a distance between the store having the target product in stock and a portable terminal of the user of the information processing apparatus is less than or equal to the predetermined distance.

19. The information processing apparatus according to claim 16, further comprising a decision unit that decides the target product to be associated with the user of the information processing apparatus using a behavior history of the user of the information processing apparatus.

20. The information processing apparatus according to claim 19, wherein the behavior history of the user of the information processing apparatus is a history of web pages browsed by the user of the information processing apparatus, a history of products browsed by the user of the information processing apparatus, or a history of conversion of the user of the information processing apparatus.

21. An information processing apparatus comprising:
an output control unit that outputs information related to a second product different from a first product to a user who purchased the first product,
wherein the information related to the second product includes information determining a selling area of the second product, and
the first product and the second product are sold at different selling areas in the same store.

22. The information processing apparatus according to claim 21, wherein the information related to the second product and information related to the selling area of the second product are output on a receipt.
